(19) United States
(12) Patent Application Publication
(10) Pub. No.: US 2020/0331641 A1
(43) Pub. Date: Oct. 22, 2020

(54) SOLID PREPARATION SUBDIVIDING DEVICE AND SOLID PREPARATION SUBDIVIDING METHOD

(71) Applicant: YUYAMA MFG. CO., LTD., Osaka (JP)

(72) Inventor: Hiroyuki YUYAMA, Osaka (JP)

(21) Appl. No.: 16/497,421

(22) PCT Filed: Mar. 30, 2018
(86) PCT No.: PCT/JP2018/013659

§ 371 Date: Sep. 24, 2019

(30) Foreign Application Priority Data
Mar. 30, 2017 (JP) 2017-067664

(51) Int. Cl. B65B 1/30; B65D 83/04; A61J 1/03

(52) U.S. Cl. CPC B65B 1/30; A61J 2205/30; A61J 1/03; B65D 83/0409

(57) ABSTRACT

A solid preparation subdividing device includes: an information reading device; at least one solid preparation dispensing device; and a packaging device. The solid preparation dispensing device includes: a solid preparation accommodating portion configured to receive the solid preparations charged therein; and a solid preparation pickup unit configured to discharge a desired number of solid preparations from the solid preparation accommodating portion. The information reading device is configured to read information related to an administration method from the information recording portion of the container. The packaging device is configured to individually package one or a plurality of solid preparations. Based on information related to the administration method read by the information reading device, the solid preparations are discharged from the solid preparation dispensing device on a dose-by-dose basis and delivered to the packaging device, and the solid preparations are individually packaged by the packaging device on a dose-by-dose basis.

### TECHNICAL FIELD

This disclosure relates to a device configured to subdivide solid preparations in a container on a dose-by-dose basis. This disclosure relates to a device configured to redistribute solid preparations, which have been distributed from a drug bottle or the like and filled in a drug container such as a vial bottle for individual use, and subdivide the solid preparations on a dose-by-dose basis. Further, this disclosure relates to a method of redistributing solid preparation in a container filled with solid preparations for individual use and subdividing the solid preparations on a dose-by-dose basis.

### BACKGROUND ART

In Europe and the United States, there is a tendency that drugs in a form of solid preparations such as tablets and capsules are preferred. In many cases, solid preparations are supplied in a unit of, for example, one-month dosage. The solid preparations are filled in a small container such as a vial bottle and supplied to a patient (Patent Literature 1). Further, in some cases, solid supplements such as functional foods and nutritional supplementary foods are also filled in a small container such as a vial bottle and supplied to a recipient. It is desired that he solid preparations and the solid supplements be taken at a set time and by a set dosage. Hitherto, when an administration timing arrives, a recipient picks up a required number of solid preparations (for example, solid preparations or solid supplements) from a vial bottle or the like to take the solid preparation.

### CITATION LIST

### Patent Literature

[PTL 1] JP 2008-13216 A

[PTL 2] JP 2005-289463 A

### SUMMARY OF INVENTION

### Technical Problem

With regard to pharmaceutical drugs, in some cases, a plurality of drugs are taken together. This similarly applies to supplements, and there is a tendency that a person who habitually takes supplements takes a plurality of supplements. In some cases, a recipient takes the pharmaceutical drugs and the supplements outside at an administration time. Therefore, a recipient puts vial bottles filled with, for example, pharmaceutical drugs in a bag and carries the vial bottles around. Some people who habitually takes supplements always carry the vial bottles. The vial bottle is not so large, but may be bulky when a plurality of vial bottles for respective kinds of supplements are carried. Therefore, consumers desire to subdivide the solid preparations in the vial bottles so that the solid preparations can easily be taken and carried around. Further, in some cases, a dosage of pharmaceutical drugs such as medicines for cold may vary depending on administration timings. For example, one tablet is taken in the morning, two tablets are taken in daytime, and one tablet is taken after dinner. As described above, a plurality of pharmaceutical drugs are taken together in some cases, and a recipient may feel cumbersome and is liable to make a mistake. This similarly applies to the case of supplements, and a recipient may feel cumbersome and is liable to make a mistake.

This disclosure has an object to provide a device which configured to redistribute solid preparations filled in a small container such as a vial bottle for individual use and subdivide the solid preparations on a dose-by-dose basis. Further, this disclosure has an object to provide a method of subdividing solid preparations.

### Solution to Problem

In order to solve the above-mentioned problem, according to one embodiment of the present invention, there is provided a solid preparation subdividing device, which includes a container including an information recording portion on which information related to an administration method for solid preparations is recorded and being filled with a plurality of solid preparations for an identified recipient, and is configured to subdivide the solid preparations filled in the container on a dose-by-dose basis, the solid preparation subdividing device including: an information reading device; at least one solid preparation dispensing device; and a packaging device, wherein the solid preparation dispensing device includes: a solid preparation accommodating portion configured to receive the solid preparations charged therein; and a solid preparation pickup unit configured to discharge a desired number of solid preparations from the solid preparation accommodating portion, wherein the information reading device is configured to read information related to an administration method from the information recording portion of the container, wherein the packaging device is configured to individually package one or a plurality of solid preparations, and wherein, based on information related to the administration method read by the information reading device, the solid preparations are discharged from the solid preparation dispensing device on a dose-by-dose basis and delivered to the packaging device, and the solid preparations are individually packaged by the packaging device on a dose-by-dose basis.

It is desired that the information reading device be configured to read Identification information when identification information of the solid preparations is present on the container.

In each of the above-mentioned embodiments, it is desired that the solid preparation dispensing device include a dispensing passage for allowing the solid preparations to pass therethrough, and be configured to restrict a shape of the solid preparation which passes through the dispensing passage by restricting the dispensing passage.

It is desired that an administration timing be printable on a package individually packaging the solid preparations.

It is desired that, in a case in which a plurality of solid preparation dispensing devices are provided, and solid preparations are charged into the plurality of solid preparation dispensing devices from different containers, when solid preparations being different preparation but having the same administration timing are provided, different solid preparations having the same administration timing be enclosed in the same package.

According to another embodiment, there is provided a solid preparation subdividing method, which involves use of: a container including an information recording portion on which information related to an administration method is recorded and being filled with a plurality of solid preparations for an identified recipient; and a solid preparation subdividing device, wherein the solid preparation subdividing device includes: an information reading device; at least one solid preparation dispensing device; and a packaging device, the solid preparation dispensing device including: a solid preparation accommodating portion configured to receive the solid preparation charged therein; and a solid preparation pickup unit configured to pick up a predetermined number of solid preparations from the solid preparation accommodating portion, the information reading device being configured to read information related to an administration method from the information recording portion of the container, the packaging device being configured to individually package one or a plurality of solid preparations, the solid preparation subdividing method including: charging the solid preparations filled in the container into the solid preparation accommodating portion; reading information related to the administration method from the information recording portion of the container through use of the information reading device; discharging the solid preparations from the solid preparation dispensing device based on the read information related to the administration method on a dose-by-dose basis and transferring the solid preparations to the packaging device; and individually packaging the solid preparations through use of the packaging device on a dose-by-dose basis.

### Advantageous Effects of Invention

According to the solid preparation subdividing device and the solid preparation subdividing method of this disclosure, solid preparations filled in a small container such as a vial bottle for individual use can be redistributed and subdivided on a dose-by-dose basis.

### BRIEF DESCRIPTION OF DRAWINGS

FIG. 1 is a conceptual view for illustrating a solid preparation subdividing device according to an embodiment of this disclosure.

FIG. 2 is a front view for illustrating vial bottles used in the embodiment of this disclosure.

FIG. 3 is a perspective view for illustrating a solid preparation dispensing device adopted in the solid preparation subdividing device according to the embodiment of this disclosure, as viewed from one direction.

FIG. 4 is a perspective view for illustrating the solid preparation dispensing device of FIG. 3, as viewed from a different direction.

FIG. 5 is a perspective view for illustrating the solid preparation dispensing device of FIG. 3, as viewed from a lower side.

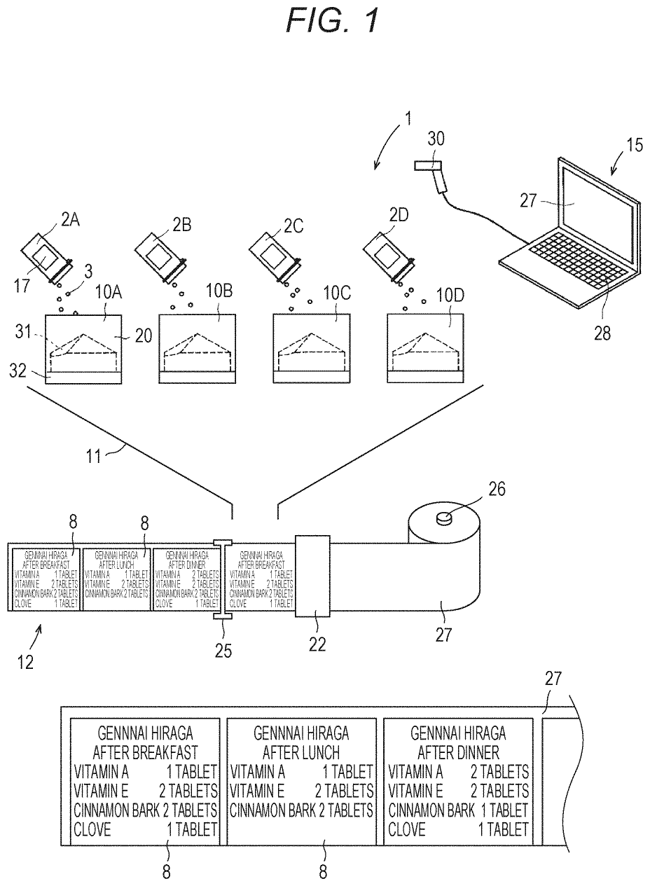

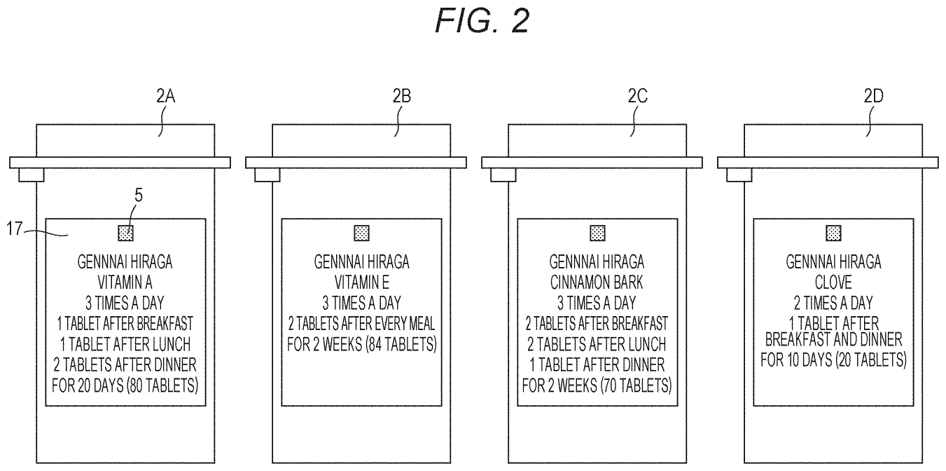

### DESCRIPTION OF EMBODIMENTS

Now, an embodiment of this disclosure is further described. A solid preparation subdividing device 1 according to this embodiment is a device configured to subdivide solid preparations 3 filled in small containers such as vial bottles 2 in accordance with use (administration) timings and further package the solid preparations 3 to produce bags (packages) 8 divided on a dose-by-dose basis. The vial bottle 2 is a small container filled with the solid preparations 3 such as drugs or supplements, and is publicly known. The vial bottle 2 of this embodiment is filled with a predetermined number of solid pharmaceutical drugs or solid supplements based on a prescription given by a doctor or an instruction given by an advisor who prepares supplements.

The vial bottle 2 adopted in this embodiment is handed to an identified patient or a supplement recipient from a pharmacist or an advisor, and is prepared for use by an identified individual. Therefore, the vial bottle 2 has, for example, a label 17 on which information regarding a user name, a use method, and a dosage is recorded. In this embodiment, both recording through use of characters and recording through recording means such as a barcode are used together. The recording of information may be recording through an electrical method such as an IC chip. In this embodiment, the label 17 is placed on the vial bottle 2, and characters and a two-dimensional barcode 5 are given on the vial bottle 2. In this embodiment, the two-dimensional barcode 5 functions as an information recording portion.

As character information printed on the label 17, there are given a component indication showing a drug name or a component, a user name indication, and indications of, for example, a use method and a dosage. Specifically, on the label (information recording portion) 17 of a vial bottle 2A, a character indication of “VITAMIN A” is given as a component indication, and a character indication of “GENNNAI HIRAGA” as a user name indication. As a use method indication, there is given a character indication of “3 TIMES A DAY, 1 TABLET AFTER BREAKFAST, 1 TABLET AFTER LUNCH, 2 TABLETS AFTER DINNER, FOR 20 DAYS (80 TABLETS)” is given. On a vial bottle 2B, a character indication of “VITAMIN E” is given as a component indication, and a character indication of “GENNNAI HIRAGA” as a user name indication. As a use method indication, there is given a character indication of “3 TIMES A DAY, 2 TABLETS AFTER EACH MEAL, FOR 2 WEEKS (84 TABLETS)” is given. On a vial bottle 2C, a character indication of “CINNAMON BARK” is given as a component indication, and a character indication of “GENNNAI HIRAGA” as a user name indication. As a use method indication, there is driven a character indication of “3 TIMES A DAY, 2 TABLETS AFTER BREAKFAST, 2 TABLETS AFTER LUNCH, 1 TABLET AFTER DINNER, FOR 2 WEEKS (70 TABLETS)” is given. On a vial bottle 2D, a character indication of “CLOVE” is given as a component indication, and a character indication of “GENNNAI HIRAGA” as a user name indication. As a use method indication, there is given a character indication of “2 TIMES A DAY, 1 TABLET AFTER BREAKFAST AND DINNER, FOR 10 DAYS (20 TABLETS)” is given.

Moreover, information corresponding to a component, a user name, a use method, and a dosage is written in the two-dimensional barcode 5. Further, identification information of solid preparations is recorded in the two-dimensional barcode 5. The identification information is information capable of identifying a kind of a tablet (drug), and examples thereof include a drug name, a drug ID, a drug code, a JAN code, an RSS code, and an OR code (trademark). In some cases, the identification information is recorded separately from the two dimensional barcode 5 described above.

The solid preparation subdividing device 1 according co this embodiment includes a plurality of solid preparation dispensing devices 10, a collection hopper 11, a packaging device 12, and a control device 15. The solid preparation dispensing device 10 includes a solid preparation accommodating portion 20 configured to accommodate the solid preparations 3, and is configured to discharge a desired number of solid preparations 3 in the solid preparation accommodating portion 20. In the solid preparation dispensing device 10, a number detection unit 32 configured to detect the number of discharged drugs is provided below the solid preparation accommodating portion 20. The solid preparation dispensing device 10 is controlled by the control device 15, and is configured to discharge the solid preparations 3 on a dose-by-dose basis. The solid preparation dispensing device 10 is capable of restricting a practical wideness of a dispensing passage for allowing the solid preparations 3 to pass therethrough, to thereby restrict the shape of the solid preparations which may pass through the dispensing passage, and is capable of handling a plurality of kinds of solid preparations 3. A configuration of the solid preparation dispensing device 10 is described later.

The plurality of solid preparation dispensing devices 10 are arranged side by side in one row. When the number of solid preparation dispensing devices 10 is large, the solid preparation dispensing devices 10 are arrayed in a plurality of stages so that the solid preparation dispensing devices 10 are arranged in a three-dimensional arrangement.

The collection hopper 11 is provided below the group of solid preparation dispensing devices, and is configured to collect the solid preparations 3 discharged from the solid preparation dispensing devices 10 and supply the solid preparations 3 to the packaging device 12.

The packaging device 12 includes a printing portion 22, a bag-portion forming mechanism (not shown), and a partition forming device 25. The partition forming device 25 functions also as a sheet feeding mechanism. The sheet feeding mechanism is a device configured to pay out a sheet-like drug package paper 27 wound around a roll shaft 26 and feed the drug package paper 27 to a printing portion 22 and the bag-portion forming mechanism (not shown) on a downstream side. In this embodiment, the drug package paper 27 is folded in half in advance, and the drug package paper 27 folded in half is wound in a roll shape. That is, the drug package paper 27 is formed by folding one sheet in half, and has a half-bag shape with a lower side in the drawing being closed and an upper side in the drawing being opened.

The printing portion 22 is configured to pint predetermined information on the drug package paper 27. In this embodiment, information such as a recipient name, a drug name or a supplement name, and an administration timing such as “AFTER BREAKFAST” or “AFTER LUNCH” is printed on the drug package paper 27.

The bag-portion forming mechanism is configured to form a bag portion with open one end by placing a plate (not shown) onto the half-folded drug package paper 27 and opening one side of the drug package paper 27 (upper side in the drawing). A lower portion of the collection hopper 11 is open to an inside of the bag portion of the drug package paper 27, which is formed by the bag-portion forming mechanism (not shown).

The partition forming device 25 is a heat seal device. The partition forming device 25 is driven by a motor (not shown), and is configured to form bags (packages) 8 by partitioning the bag portion to divide the bag portion into individual bag portions on a package-by-package basis.

The control device 15 is a device which includes, for example, a CPU and a memory and is configured to control components of the solid preparation subdividing device 1. The control device 15 includes a monitor (display portion) 27, which is publicly known, and an input unit 28 such as a keyboard or a touch panel. Further, an information reading device 30 is mounted to the control device 15. The information reading device 30 is, for example, a barcode reader or a device configured to read information written in an IC chip. In this embodiment, a barcode reader is adopted as the information reading device 30. The information reading device 30 is not limited to the barcode reader, and may be any device configured to read information on the IC chip. Further, the information reading device 30 may be any device configured to analyze characters.

Next, functions of the solid preparation subdividing device 1 according to this embodiment are described along a procedure of use. As described above, the solid preparation subdividing device 1 according to this embodiment is a device configured to subdivide the solid preparations 3 filled in the small containers such as the vial bottles 2 in accordance with use timings and further package the solid preparations 3. When the solid preparation subdividing device 1 is used, information recorded in the two-dimensional barcode (information recording portion) 5 provided to the labels 17 of the vial bottles 2 is read through use of the information reading device 30. Further, when identification information is present, the identification information is also read through use of the information reading device 30.

A cover of the vial bottle 2 is opened, and the solid preparations in the vial bottle 2 are charged into one solid preparation dispensing device 10 having a calibration function. That is, the solid preparations in one vial bottle 2 are ail charged into the solid preparation accommodating portion 20 of one solid preparation dispensing device 10. For example, solid preparations in a vial bottle 2A are all charged into the solid preparation accommodating portion 20 of a solid preparation dispensing device 10A. Solid preparations in the vial bottle 2B are all charged into the solid preparation accommodating portion 20 of a solid preparation dispensing device 10B. Solid preparations in a vial bottle 2C are all charged into the solid preparation accommodating portion 20 of a solid preparation dispensing device 105. Solid preparations in a vial bottle 2D are all charged into the solid preparation accommodating portion 20 of a solid preparation dispensing device 10D.

Then, the input unit 28 of the control device 15 is operated so as to identify the solid preparation dispensing device 10 into which the vial bottle 2 is charged. In the example described above, the fact that the solid preparations in the vial bottle 2A have been charged into the solid preparation dispensing device 10A is input to he control device 15 through operation on the input unit 28. This similarly applies to other vial bottles 2B, 2C, and 2D.

After the operation of charging the solid preparations 3 and identifying the solid preparation dispensing device 10 into which the solid preparations 3 have been charged is terminated, a start switch (not shown) is operated so as to start subdividing operations. In this embodiment, prior to the specific subdividing operations, it is confirmed that the same recipient is associated with the vial bottles In this embodiment, an administration target of each vial bottle 2 is read from the two-dimensional barcode 5 given to each of the vial bottles 2, and it is confirmed that the administration target of each of the vial bottles 2 is “GENNAI HIRAGA”. When solid preparations for other recipient is mixed, a predetermined notification is given, and subsequent subdividing operations are stopped.

When the administration target of the vial bottles 2 is the same person, the subdividing operations are performed, and the solid preparation dispensing devices 10 are driven, thereby discharging the solid preparations 3 having the same administration timing on a dose-by-dose basis. For example, in accordance with the example described above, as the solid preparation 3 to be taken after breakfast, one tablet of the “VITAMIN A” having been charged from the solid preparation dispensing device 10A into the vial bottle 2A is discharged, and two tablets of the “VITAMIN E” having been charged from the solid preparation dispensing device 10B into the vial bottle 2B are discharged. Further, two tablets of “CINNAMON BARK” having been charged from the solid preparation dispensing device 10C into the vial bottle 2C are discharged, and one tablet of “CLOVE” having been charged from the solid preparation dispensing device 10D into the vial bottle 2D is discharged.

The solid preparations 3 for one administration, which have been discharged from the solid preparation dispensing devices 10 and are to be taken after breakfast, are collected by the collection hopper 11 and delivered to the packaging device 12. Then, all of the solid preparations 3 are placed in one bag portion of the drug package paper 27 formed by the bag-portion forming mechanism (not shown). Moreover, prior to the placement of the solid preparations 3, required information is printed on the bag portion by the printing portion 22 provided on the upstream side. That is, characters of “GENNAI HIRAGA” are printed as an indication for identifying a recipient. Moreover, as an indication of an administration timing, characters of “AFTER BREAKFAST” are printed. Further, as required, kinds and numbers of the solid preparations 3 to be packaged are printed.

The bag portion having the solid preparations 3 charged therein is delivered to a partition forming device (heat seal device) 25 provided on the downstream side, and is partitioned into an independent bag (package) 8 with three sides thereof being thermally fused. Subsequently, the series of subdividing operations described above are automatically repeated. That is, solid preparations 3 corresponding to the next administration timing are discharged from the solid preparation dispensing devices 10 and delivered to the packaging device 12 via the collection hopper 11, and all of the solid preparations 3 are placed in one bag of the drug package paper 27. Further, prior to this operation, required information is printed on the bag portion by the printing portion 22 provided on the upstream side.

Specifically, the next administration timing is after lunch, and hence, as the solid preparations 3 to be taken after lunch, one tablet of “VITAMIN A” filled in the vial bottle 2A is discharged from the solid preparation dispensing device 10A, and two tablets of “VITAMIN E” filled in the vial bottle 2B are discharged from the solid preparation dispensing device 10B. Further, two tablets of “CINNAMON BARK” filled in the vial bottle 2C are discharged from the solid preparation dispensing device 10C, The “CLOVE” charged in the vial bottle 2D is not to be taken after lunch, and hence the solid preparations 3 are not discharged from the solid preparation dispensing device 10D. Further, characters of “GENNAI HIRAGA” are printed on the bag portion as an indication for identifying a recipient. Further, as an indication of an administration timing, an indication of “AFTER LUNCH” is printed.

Next, solid preparations 3 to be taken after dinner are discharged from the solid preparation dispensing devices 10 and are packaged in one bag portion by the packaging device 12. Solid preparations 3 to be taken in the order of “AFTER BREAKFAST”, “AFTER LUNCH”, and “AFTER DINNER” are enclosed in respective bags 8, and packaging of solid preparations for one day is completed, solid preparations 3 to be taken “AFTER BREAKFAST”, “AFTER LUNCH”, and “AFTER DINNER” of the next day are sequentially enclosed in respective bags 8. In such a manner, the subdividing operations are continued until all of the solid preparations 3 in the solid preparation dispensing devices 10 are discharged.

When there is any excess or shortage of the solid preparations 3 filled in the vial bottles, and the solid preparations 3 to be enclosed in one bag 8 are insufficient, the subdividing operations are interrupted, and this fact is displayed on the monitor (display portion) 27. For example, even though solid preparations 3 for two weeks are filled in the vial bottles 2A, 2B, and 2C, when solid preparations 3 for only ten days are filled in the vial bottle 2D, the subdividing operations are interrupted at the timing of completion of bags 8 for ten days, and this fact is displayed on the display portion. A user can restart the subdividing operations while knowing that there is shortage, or can discharge the remaining solid preparations 3 and collect the same in the vial bottles 2. This selection is performed through manual operation on the input unit 28 of the control device 15. Alternatively, the selection may be performed in accordance with setting input in advance.

In the embodiment described above, the solid preparations 3 to be charged into the solid preparation dispensing devices 10 are all prepared with drugs for individual use. However, this disclosure is not limited to this configuration, and drugs or supplements available for the public may be mixed. For example, the vitamin preparations to be charged into the solid preparation dispensing devices 10A and 10B are prepared based on prescription given by a doctor for individual use by a patient, but supplements to be charged into the solid preparation dispensing devices 10C and 10D may be those purchased in accordance with preference of a user.

In the embodiment described above, or to the specific subdividing operations, identification is made on whether or not a recipient of the vial bottles 2 is the same. However, when drugs or supplements which are available for the public are mixed, the identification of whether or not a recipient is the same is omitted. Further, the administration timing and the dosage are separately input through use of the input unit 28.

Next, description is made of the solid preparation dispensing device 10. The solid preparation dispensing device 10 adopted in this embodiment includes the solid preparation accommodating portion 20 configured to accommodate the solid preparations 3, and is configured to discharge only a desired number of solid preparations 3 in the solid preparation accommodating portion 20. Further, it is desired that the solid preparation dispensing device 10 adopted in this embodiment be capable of handling solid preparations 3 of various shapes and structures and discharging one or a plurality of solid preparations 3 at a time. That is, the solid preparations 3 are roughly classified into a tablet and a capsule in terms of structure. Moreover, examples of the shape of the tablet include a fiat circular shape, an elliptical shape, and a spherical shape. The size of the tablet varies. This similarly applies to the capsule, and the size of the capsule varies.

In order to be capable of handling solid preparations 3 of a plurality of shapes and structures, the solid preparation dispensing device 10 adopted in this embodiment increases or decreases the wideness of the dispensing passage for allowing the solid preparations 3 to pass therethrough to limit the shape of the solid preparation which may pass through the dispensing passage, thereby being capable of handling a plurality of kinds of solid preparations 3.

That is, in order to discharge one solid preparation 3, at a time, it is required that the solid preparations 3 be arrayed in a row at some positions. When the dispensing passage is wide, the plurality of solid preparations 3 are arranged in parallel, and a plurality of solid preparations may be discharged at a time. In contrast, when the dispensing passage is narrow, the solid preparation 3 cannot pass through the dispensing-passage, and hence the solid preparation 3 cannot be discharged. Therefore, in order to discharge one solid preparation 3 at a time, it is required to change the size (wideness) of the dispensing passage in accordance with the solid preparations 3 to be stored.

The solid preparation dispensing device 10 in this embodiment is capable of suitably adjusting a height and a width of the dispensing passage by restricting the dispensing passage for the solid preparations 3. Thus, even when solid preparations 3 of any shape and size are charged into the solid preparation accommodating portion 20, a desired number of solid preparations can be discharged without delay.

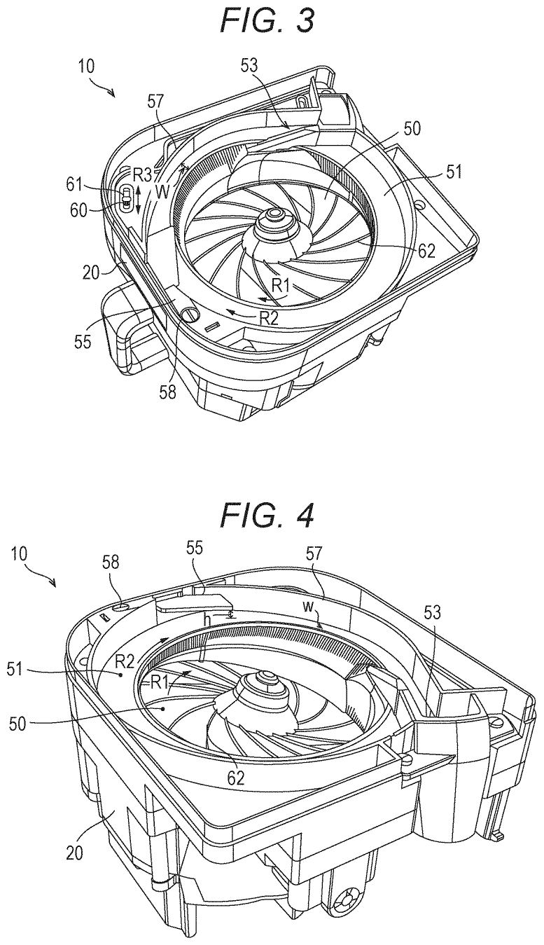

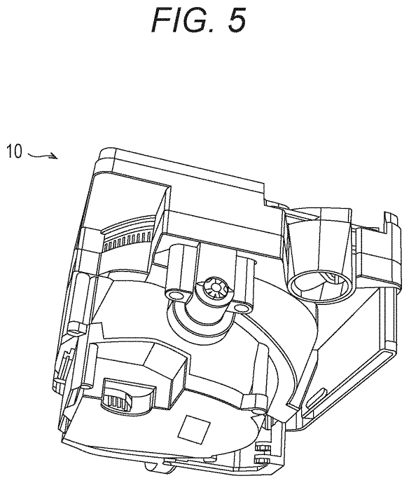

Now, description is made. The solid preparation dispensing device 10 includes, as illustrated in FIG. 3 and FIG. 4, the solid preparation accommodating portion 20 configured to accommodate a plurality of solid preparations 3, a first rotating member 50, and a second rotating member 51. In FIG. 3 and FIG. 4, a cover member configured to cover an upper part is omitted. The first rotating member 50 is a disc-shaped member forming a bottom surface of the solid preparation accommodating portion 20. A rotation axis of the first rotating member 50 is inclined by a predetermined angle with respect to a vertical direction so that an upper surface of the first rotating member 50 is inclined by a predetermined angle with respect to a horizontal plane. Further, radial ribs 62 are formed at predetermined intervals on the upper surface of the first rotating member 50. The first rotating member 50 is rotatably supported by a housing of the solid preparation dispensing device 10, and is rotated by a motor (not shown). Further, the first rotating member 50 is raised and lowered.

The second rotating member 51 is a hollow annular member arranged around the first rotating member 50 in plan view. The second rotating member 51 is located on an upper side of the solid preparation accommodating portion 20. An upper end portion of the first rotating member 50 described above is located on the same horizontal plane as the second rotating member 51. The second rotating member 51 is also rotatably supported by the housing of the solid preparation dispensing device 10, and is rotated by a motor (not shown).

A part of the second rotating member 51 is continuous with a discharge port 53 for discharging the solid preparation 3 from the solid preparation accommodating portion 20. Through the rotation of the second rotating member 51, the solid preparation 3 is conveyed to the discharge port 53. Thus, an upper part of the second rotating member 51 forms a part of the dispensing passage for allowing the solid preparation 3 to pass therethrough. In this embodiment, on the dispensing passage for conveying the solid preparation 3 to the discharge port 53 by the second rotating member 51, there are arranged a height restriction member 55 and a width restriction member 57.

The height restriction member 55 is provided on the second rotating member 51, and is configured to restrict a height from a conveyance surface of the second rotating member 51. The height restriction member 55 is configured to restrict a height of an object passing this part. The height restriction member 55 is configured to restrict the size of the solid preparation 3, which can be conveyed to the discharge port 53 by the second rotating member 51, in a height direction.

Meanwhile, the width restriction member 57 protrudes from a side of the second rotating member 51 toward a region (dispensing passage) of the second rotating member 51, and is configured to temporarily reducing a width of a conveyance passage of the second rotating member 51. The width restriction member 57 is configured to restrict, through use of the second rotating member 51, the size of the solid preparations 3 which can be conveyed to the discharge port 53. With this configuration, in the solid preparation dispensing device 10, among tablets placed on the second rotating member 51, only tablets having the size within a height “h” restricted by the height restriction member 55 and a width “w” restricted by the width restriction member 57 are dispensed from the discharge port 53. Thus, in the solid preparation dispensing device 10, when the height and the width of one tablet accommodated in the solid preparation accommodating portion 20 satisfy the height “h” and the width “w”, the tablet is dispensed on a one-by-one basis.

The width restriction member 57 is supported so as to be rotatable about a perpendicular axis (not shown) with respect to the housing of the solid preparation dispensing device 10. The width restriction member 57 turns in the horizontal direction through driving of a motor (not shown), thereby changing a projection amount of the width restriction member 57 toward the solid preparation accommodating portion 20 side (region of the second rotating member 51) and changing the width “w” restricted by the width restriction member 57. That is, the solid preparation dispensing device 10 includes a width adjustment member 60 configured to change the width “w” restricted by the width restriction member 57. A pinion gear is formed on an outer peripheral surface of the width adjustment member 60, and is engaged with a rack (gear) formed on an inner peripheral surface of an elongated hole 61 formed in the width restriction member 51. The projection amount of the width restriction member 57 toward the solid preparation accommodating portion 20 side is changed by relative movement of the width adjustment member 60 and the elongated hole 61 in the arrow R3 direction (see FIG. 3) by the rotation of the width adjustment member 60.

Further, the solid preparation dispensing device 10 includes a height adjustment portion 58 configured to change the height “h” restricted by the height restriction member 55. The height adjustment portion 58 is rotatably supported on the housing of the solid preparation dispensing device 10. The height adjustment portion 58 is rotated by a motor (not shown) so that a position of a lower end portion thereof is moved in an up-and-down direction, thereby changing the height “h” restricted by the height restriction member 55.

In the solid preparation dispensing device 10 of this embodiment, the first rotating member 50 and the second rotating member 51 are rotated by a motor (not shown). Further, the first rotating member 50 is raised and lowered in the solid preparation accommodating portion 20. When the solid preparations 3 in the solid preparation dispensing device 10 are to be discharged, the first rotating member 50 and the second rotating member 51 are rotated. When the first rotating member 50 is rotated in the rotation direction R1 (see FIG. 3 and FIG. 4), tablets in the solid preparation accommodating portion 20 are discharged from the first rotating member 50 to the second rotating member 51. Further, when the second rotating member 51 is rotated in the rotation direction R2 (see FIG. 3 and FIG. 4), tablets on the second rotating member 51 are conveyed toward the discharge port 53.

However, in this embodiment, the dispensing passage for the solid preparations 3 is restricted by the height restriction member 55 and the width restriction member 57, and hence the height and the width are restricted. Therefore, among the solid preparations 3 conveyed by the second rotating member 51, tablets stacked in the height direction are brought into contact with the height restriction member 55 and returned co the solid preparation accommodating portion 20. Further, among the tablets conveyed by the second rotating member 51, the solid preparations 3 arrayed in the width direction are brought into contact with the width restriction member 57 and returned to the solid preparation accommodating portion 20. Thus, in the solid preparation dispensing device 10 of this embodiment, tablets having the size corresponding to the height “h” restricted by the height restriction member 55 and the width “w” restricted by the width restriction member 57 are conveyed to the discharge port 53 in a state of being aligned one-by-one basis in the circumferential direction on the second rotating member 51. Therefore, in the solid preparation dispensing device 10, the tablets accommodated in the solid preparation accommodating portion 20 can be dispensed on one-by-one basis, thereby being capable of controlling the dispensing amount of the tablets.

The solid preparation dispensing device 10 described above restricts both the height and the width of the passage for allowing the solid preparation 3 to pass therethrough. However, the solid preparation dispensing device 10 may restrict only one of the height and the width. Moreover, this disclosure may have a configuration in which the dispensing passage for the solid preparations 3 is fixed and the height and the width cannot be changed.

The solid preparation dispensing device 10 may have a configuration in which a rotor is provided in the solid preparation accommodating portion 20 as disclosed in, for example, Patent Literature 2. The rotor has a vertical groove, and the solid preparations 3 are fitted to the vertical groove. Further, through rotation of the rotor, the vertical groove reaches a position of the discharge port, and the solid preparations 3 fitted in the vertical groove are discharged from the solid preparation accommodating portion 20.

The solid preparation pickup unit is not limited to the configuration described above, and may be configured to push out solid preparations one by one through use of, for example, a pusher. Moreover, the solid preparation pickup unit may be configured to discharge the solid preparations one by one through use of vibration. For example, the solid preparation pickup unit may have the following structure. A guide track for allowing the solid preparations to proceed is provided, and the guide track is vibrated to transfer the solid preparations along the guide track.

### REFERENCE SIGNS LIST

1 solid preparation subdividing device, 2 vial bottle, 3 solid preparation (information recording portion), 5 two-dimensional barcode, 8 bag (package), 10 solid preparation dispensing device, 11 collection hopper, 12 packaging device, 15 control device, 20 solid preparation accommodating portion, 30 information reading device

1. A solid preparation subdividing device, comprising:
a container comprising an information recording portion;
an information reading device;
at least one solid preparation dispensing device comprising a solid preparation accommodating portion and a solid preparation pickup unit; and
a packaging device,
wherein:
the container is configured to receive a plurality of solid preparations,
the solid preparation accommodating portion is configured to receive solid preparations; and
the solid preparation pickup unit is configured to discharge a desired number of the received solid preparations from the solid preparation accommodating portion,
the information reading device is configured to read information related to an administration method from the information recording portion,
the packaging device is configured to individually package one or a plurality of the discharged solid preparations,
based on the read information related to the administration method, the solid preparation dispensing device is configured to discharge the solid preparations on a dose-by-dose basis to the packaging device, and
the packaging device is configured to individually package the discharged solid preparations on a dose-by-dose basis.

2. The solid preparation subdividing device according to claim 1, wherein the information reading device is configured to read identification information when identification information of the solid preparations is present on the container.

3. The solid preparation subdividing device according to claim 1, wherein the solid preparation dispensing device further comprises a dispensing passage configured to allow the solid preparations to pass therethrough, while restricting a shape of the solid preparations which pass through the dispensing passage.

4. The solid preparation subdividing device according to claim 1, further comprising a printer configured to print an administration timing on a package individually packaging the solid preparations.

5. The solid preparation subdividing device according to claim 4 further comprising a bag-forming mechanism, wherein
the at least one solid preparation dispensing device includes a plurality of solid preparation dispensing devices configured to receive solid preparations different containers, and the bag-forming mechanism is configured to enclose different solid preparations having the same administration timing in the same package.

6. A solid preparation subdividing method using
a container including an information recording portion on which information related to an administration method is recorded and being filled with a plurality of solid preparations for an identified recipient; and
a solid preparation subdividing device,
wherein the solid preparation subdividing device includes:
an information reading device;
at least one solid preparation dispensing device; and
a packaging device,
the solid preparation dispensing device including:
a solid preparation accommodating portion configured to receive the solid preparation charged therein; and
a solid preparation pickup unit configured to pick up a predetermined number of solid preparations from the solid preparation accommodating portion,
the information reading device being configured to read information related to an administration method from the information recording portion of the container,
the packaging device being configured to individually package one or a plurality of solid preparations,
the solid preparation subdividing method comprising:
charging the solid preparations filled in the container into the solid preparation accommodating portion;
reading information related to the administration method from the information recording portion of the container through use of the information reading device;
discharging the solid preparations from the solid preparation dispensing device based on the read information related to the administration method on a dose-by-dose basis and transferring the solid preparations to the packaging device; and
individually packaging the solid preparations through use of the packaging device on a dose-by-dose basis.
